(19) United States
(12) Patent Application Publication
(10) Pub. No.: US 2022/0037807 A1
(43) Pub. Date: Feb. 3, 2022

(54) PLUG FOR A PROFILED SAFETY SECTION AND A SAFETY EDGE

(71) Applicant: BBC BIRCHER AG, Beringen (CH)

(72) Inventors: Liebmer Trauschein, Thayngen (CH); Adrian Fetz, Neuhausen am Rheinfall (CH); Dietmar Hosp, Klettgau (DE); Thomas Ha, Schaffhausen (CH)

(73) Assignee: BBC BIRCHER AG, Beringen (CH)

(21) Appl. No.: 17/280,307

(22) PCT Filed: Sep. 17, 2019
(86) PCT No.: PCT/EP2019/074875

§ 371 Date: Mar. 26, 2021

(30) Foreign Application Priority Data
Sep. 27, 2018 (DE) 10 2018 123 877.0

(51) Int. Cl. H01R 4/16; H01R 4/2407

(52) U.S. Cl. CPC H01R 4/16; H01R 4/2407

(57) ABSTRACT

A plug (1) for a profiled safety edge section (2), comprising a first contact element for a first wire (3) of the profiled safety edge section (2), a second contact element for a second wire (4) of the profiled safety edge section (2), and an insertion nose (16), wherein the two contact elements are received in the insertion nose (16). The first contact element is a first support (8) with a first claw (9), and the second contact element is a second support (10) with a second claw (11).

### BACKGROUND OF THE INVENTION

The present invention relates to a plug for a safety switching profile and to a safety switching profile.

From the state of the art reference is made to the DE 10 2011 003 063 A1, which describes an electrical switching strip with an elastic switching profile that has at least two electrical conductors arranged in the switching profile, whereby the conductors are formed as metal wires or metal strands at least in an area protruding beyond a first end of the switching profile and with a terminating element which is electrically connected to the metal wires or metal strands in the area of the first end of the switching profile, whereby the terminating element is formed as a surface-mountable SMD component with at least two contact surfaces and the contact surfaces of the terminating element are directly connected to the metal wires or metal strands protruding beyond the first end of the switching profile.

Further reference is made to a safety switching device from the WO 2012/025198 A1, whereby in particular for power-operated systems, such as roller doors, roller grilles, doors, lifting platforms, working platforms and the like, with at least one switching chamber with at least two buttons which, when touched, trigger a switching signal supplied to an evaluation unit, whereby the buttons can each be connected to a switching line at the end of the switching area, whereby a plug is provided which can be plugged onto the switching chamber at the end and can be clamped to the switching chamber.

### SUMMARY OF THE INVENTION

The object of the present invention is to provide a plug for a safety switching profile, which can be manufactured quickly and easily, whereby simple assembly is also to be achieved. Further, in this context, a high level of functional reliability is to be achieved with a high degree of durability.

The features disclosed herein lead to the achievement of the object.

Preferred embodiments can also be found herein and in the dependent claims.

A plug according to the invention is used for the connection and subsequent signal reception and signal transmission of a safety switching profile. In this context, the safety switching profile is made of rubber material.

Thereby, the safety switching profile has a first electrically conductive switching profile section and a second electrically conductive switching profile section. The first switching profile section comprises a first stranded wire. The second switching profile section in turn comprises a second stranded wire. The two stranded wires are inserted approximately centrally in the longitudinal direction of the two switching profile sections or are co-extruded, for example.

Furthermore, the plug has a first contact element and a second contact element. According to the invention, the two contact elements are provided with a claw structure. Thereby, the first contact element is provided as a first support with a first claw and the second contact element is provided as a second support with a second claw.

The claw structure, which in each case consists of the support for reaching into the safety switching profile and the respective claw for engaging in the respective switching profile section in order to be able to establish an electrically conductive contact with the respective stranded wire in this way.

In interaction with the support and the positioning in the plug, the claws form a contact transfer for signal transmission. Thereby, the claws can have a barbed structure. With the shape of the claws, it is essential that it is as easy as possible to push them into the safety switching profile and that the respective switching profile section can be contacted, whereby it should be more difficult to pull the plug out of the inserted safety switching profile.

For this purpose, the claws have an ascending shape from one end of the respective support toward another end of the respective support, and then go over to a straight line arranged substantially at a right angle to the support.

Further, the first support may have at least two first claws and/or the second support may have at least two second claws. More than one claw per support is also possible to be covered by the invention. In this case, further claws on one and the same support also regularly have the same shape. Different shapes and sizes of claws are also conceivable.

The supports and the respective claw are formed in one piece and consist of a metallic material that is electrically conductive. In particular, the claw is electrically conductive and the material of the support is electrically insulating.

Furthermore, the plug according to the invention comprises an insertion nose whereby the two contact elements are received in the insertion nose. The shape of the insertion nose and the positioning of the two contact elements according to the invention consisting of the support and the claw are adapted to the inner structure of the safety switching profile in such a way that when the plug is inserted into the safety switching profile, contact is made between the respective claw and the electrically conductive switching profile section.

The first stranded wire is arranged in the first switching profile section of the electrical safety switching profile and the second stranded wire is arranged in the second switching profile section of the electrical safety switching profile, whereby the two switching profile sections are formed complementary to each other in a common switching profile space. Complementary here means that the first switching profile section is a bulge in cross-section and that the second switching profile section has a channel shape in cross-section, so that the first switching profile section can be introduced into the second switching profile section flush with the shape.

In a preferred embodiment, the two supports are a C- or U-profile in the form of a contact clip. The plug forms a channel between the two limbs of the U-profile. The channel can be inserted between the first switching profile section of the electrical safety switching profile and the second switching profile section of the electrical safety switching profile.

The channel advantageously ensures that the plug is centred in a defined manner when it is inserted into the safety switching profile and that the switching profile section space is also aligned and stretched via the insertion nose, thus providing additional protection and sealing.

Due to the U- or C-profile, a permanent preload of the electrical contact force can be easily adjusted during manufacture. Furthermore, compression of the insertion nose is achieved. The compression has the advantage here that a tight fit of the insertion nose is possible. To ensure corrosion protection, a coating of the support and the claw is given. For example, such corrosion protection can be achieved by a nickel coating.

In addition, the insertion nose has a sealing element. The sealing element is preferably arranged as a rising lamellar structure from the insertion nose to a plug housing. Advantageously, this achieves additional fastening and clamping of the plug in the safety switching profile.

Further, the plug has a signal cable. The signal cable is connected at one end to the supports and at the other end to a signal-processing computer.

A safety switching profile according to the invention comprises a first stranded wire and a second stranded wire and a plug. The first stranded wire is arranged in a first switching profile section and the second stranded wire is arranged in a second switching profile section. The two switching profile sections are formed complementary to each other in a common switching profile space.

The first switching profile section and the second switching profile section are arranged on opposite sides in the switching profile space, so that when the switching profile space is compressed, the first switching profile section can be retracted into the second switching profile section in a complementary manner. In this case, the switching profile space is enclosed by a rubber tube.

The rubber tube also forms a first flank and a second flank, whereby the two flanks can be clamped to a fastening profile at the other end of the rubber tube, whereby the fastening profile is formed, for example, as part of a sliding gate.

The plug has a first contact element for the first switching profile section and a second contact element for the second switching profile section, whereby according to the invention the first contact element consists of the first support with the first claw and the second contact element consists of the second support with the second claw.

### BRIEF DESCRIPTION OF THE DRAWINGS

Further advantages, features and details of the invention result from the following description of preferred embodiments and from the drawings; these show in

FIG. 1 a plug according to the invention from an oblique top view;

FIG. 2 the plug according to FIG. 1 in partial exploded view;

FIG. 3 a contact element according to the invention as an U-profile;

FIG. 4 a safety switching profile according to the invention and the plug according to FIG. 1, viewed from oblique above.

### DETAILED DESCRIPTION

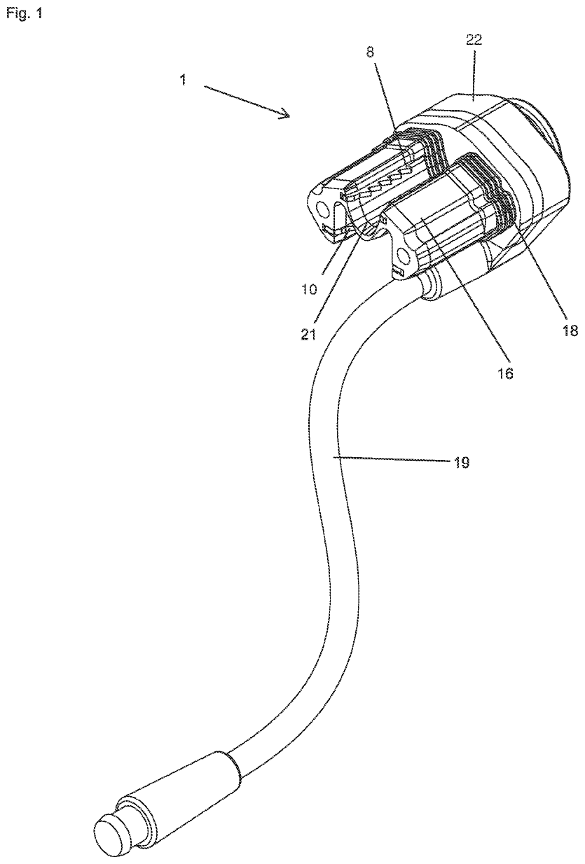

FIG. 1 shows a plug 1. In detail, the plug 1 consists of an insertion nose 16, which is integrally formed on a plug housing 22. Furthermore, the plug housing 22 comprises a signal cable 19.

Further shown is a first support 8 and a second support 10, which are shown received in the insertion nose 16.

In addition, a channel 21 is also shown, which is arranged between the first support 8 and the second support 10, whereby the convex shape is formed from the first support 8 towards the second support 10.

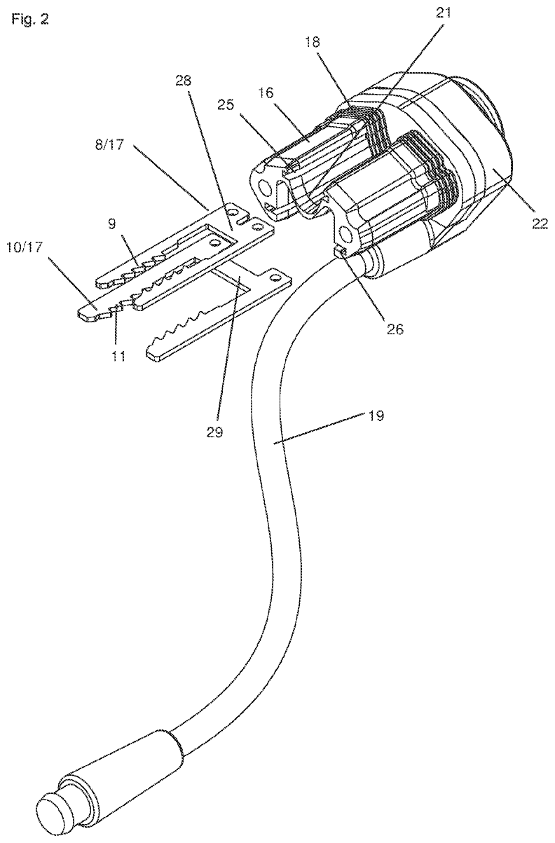

FIG. 2 shows essentially the same view as in FIG. 1, but the two supports 8, 10 are shown in a position pulled out of the insertion nose 16. It can be clearly seen how the two supports 8, 10 are formed as a U-profile 17 in this embodiment.

It is further shown how the first support 8 forms a first claw 9. In this case, the claw 9 is formed from the first support 8 slowly ascending towards a first bridge 28 and then descends again towards the first support 8 in an almost rectangular arrangement with respect to the first support 8. In the embodiment shown here, a plurality of first claws 9 can be seen.

Next to this, it can be seen how the second support 10 also has a second claw 11, which is formed from the second support 10 slowly ascending towards a second bridge 29 and then descends back towards the second support 10 in an almost rectangular arrangement with respect to the second support 10. In the embodiment shown herein, a plurality of second claws 11 can be seen.

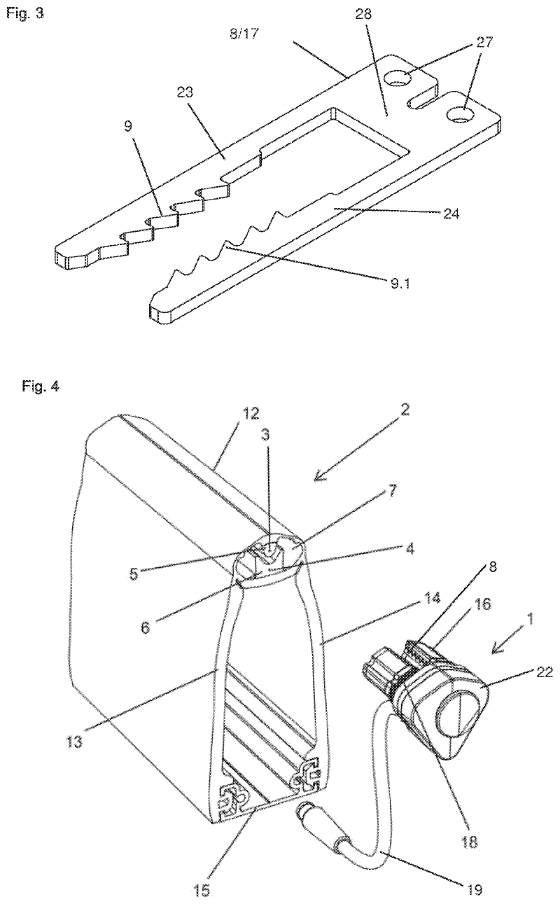

FIG. 3 shows an enlarged view of the first support 8. It is shown how the first bridge 28 forms a first limb 23 on the one hand and a second limb 24 on the other. The two limbs 23, 24 form the U-profile 17 with the first bridge 28. The first limb forms the first claw 9 and the second limb 24 forms the first claw 9.1. Furthermore, a joint 27 is let into the first bridge 28 on the other side of the two limbs 23, 24, which can be connected to the signal cable not shown here, in order to be able to pass on signals that have been received.

FIG. 4 shows a safety switching profile 2 according to the invention and the plug 1 from FIGS. 1 to 3. With regard to the plug 1, the features from FIGS. 1 to 3 are not repeated, whereby the explanations should of course also refer to the plug shown here.

The safety switching profile 2 consists primarily of a rubber tube 12, to which a first flank 13 and a second flank 14 are foldable formed. The rubber tube 12 encloses a switching profile space 7, which in turn accommodates the first switching profile section 5 and the second switching profile section 6. The two switching profile sections 5, 6 are arranged opposite one another in the switching profile space in such a way that, when pressure is applied to the rubber tube 12, the two switching profile sections 5, 6 can slide into one another in a complementary manner.

In the process, signals, for example in the form of an electrical resistance, between a first stranded wire 3 in the first switching profile section 5 and a second stranded wire 4 in the second switching profile section 6 are matched with one another and, if necessary, a signal is generated which, when the plug 1 is inserted, is transmitted via the signal cable 19 to a signal processing computer which is not shown in more detail.

Also shown is a fastening profile 15 into which the respective ends of the two flanks 13, 14 can be clamped for fastening.

### REFERENCE LIST

1 plug

2 safety switching profile

3 first stranded wire

4 second stranded wire

5 first switching profile section

6 second switching profile section

7 switching profile space

8 first support

9 first claw

10 second support

11 second claw

12 rubber tube

13 first flank

14 second flank

15 fastening profile

16 insertion nose

17 U-profile

18 sealing element

19 signal cable

20 U-profile

21 channel

22 plug housing

23 first limb

24 second limb

25 first insertion channel

26 second insertion channel

27 joint

28 first bridge

29 second bridge

1. Plug (1) for a safety switching profile (2) having a first contact element for a first switching profile section (5) of the safety switching profile (2) and a second contact element for a second switching profile section (6) of the safety switching profile (2), and an insertion nose (16), whereby the two contact elements are received in the insertion nose (16),
wherein
the first contact element is a first support (8) with a first claw (9) and the second contact element is a second support (10) with a second claw (11).

2. Plug according to claim 1, wherein a first stranded wire (3) is arranged in the first switching profile section (5) of the electrical safety switching profile (2) and a second wire (4) is arranged in the second switching profile section (6) of the electrical safety switching profile (2), whereby the two switching profile sections (5, 6) are formed complementary to each other in a common switching profile space (7).

3. Plug according to claim 1, wherein the supports (8, 10) are a U-profile (17, 20).

4. Plug according to claim 1, wherein the first support (8) has at least two first claws (9) and/or the second support (10) has at least two second claws (11).

5. Plug according to claim 3, wherein a channel (21) is formed between the two limbs of the U-profiles (17, 20), whereby the channel (21) can be inserted between the first switching profile section (5) of the electrical safety switching profile (2) and the second switching profile section (6) of the electrical safety switching profile (2).

6. Plug according to claim 1, wherein the insertion nose (16) has a sealing element (18).

7. Plug according to claim 1, wherein a signal cable (19) is connected to the two contact elements.

8. Safety switching profile (2) with a first stranded wire (3) and a second stranded wire (4) and a plug (1), whereby the first stranded wire (3) is arranged in a first switching profile section (5) and the second stranded wire (4) is arranged in a second switching profile section (6), whereby the two switching profile sections (5, 6) are formed complementary to each other in a common switching profile space (7), whereby the plug (1) has a first contact element for the first switching profile section (5) and a second contact element for the second switching profile section (6),
wherein
the first contact element is a first support (8) with a first claw (9) and the second contact element is a second support (10) with a second claw (11).

9. Safety switching profile (2) according to claim 8, wherein the first switching profile section (5) and the second switching profile section (6) are arranged in the switching profile space (7) on opposite sides, whereby the switching profile space (7) is surrounded by a rubber tube (12).

10. Safety switching profile (2) according to claim 9, wherein the rubber tube (12) forms a first flank (13) and a second flank (14), whereby the two flanks (13, 14) can be clamped to a fastening profile (15) at the other end of the rubber tube (12).
